(19) United States
(12) Patent Application Publication
(10) Pub. No.: US 2023/0362060 A1
(43) Pub. Date: Nov. 9, 2023

(54) SYSTEMS AND METHODS FOR CLOSED LOOP AUTOMATION BETWEEN WIRELESS NETWORK NODES

(71) Applicant: ASSIA SPE, LLC, Wilmington, DE (US)

(72) Inventor: Kenneth J. Kerpez, Long Valley, NJ (US)

(73) Assignee: ASSIA SPE, LLC, Wilmington, DE (US)

(21) Appl. No.: 17/985,845

(22) PCT Filed: Dec. 16, 2020
(86) PCT No.: PCT/US2020/065425

§ 371 Date: Nov. 12, 2022

Related U.S. Application Data
(60) Provisional application No. 63/023,804, filed on May 12, 2020.

(51) Int. Cl. H04L 41/0895; H04L 41/16; H04L 41/40

(52) U.S. Cl. CPC H04L 41/0895; H04L 41/16; H04L 41/40

(57) ABSTRACT

Described herein are systems and methods for closed loop automation between a plurality of wireless network nodes. Multiple closed loops may operate among the plurality of wireless network nodes to provide optimized performance of networks, devices, services and/or applications of one or more managed entities located among the plurality of wireless network nodes. The wireless network nodes may comprise one or more wireless network function, wireless control function, wireless network element or wireless network segment. Multiple decision elements reside at any of the plurality of wireless network nodes and perform data collection, analysis, and provide output to one or more managed entities. The multiple closed loops can provide multiple layers of computing, including one or more of cloud computing, edge computing, and/or local computing on a device. Collectively, the plurality of network nodes can form a mobile network such as a cellular network.

### A. CROSS REFERENCE

This application is US National Stage Application filed under 35 U.S.C. 371, claiming priority to International PCT Patent Application No. PCT/US20/65425, entitled, “SYSTEMS AND METHODS FOR CLOSED LOOP AUTOMATION BETWEEN WIRELESS NETWORK NODES”, naming as inventor, Kenneth J. Kerpez, and filed Dec. 16, 2020, which claims priority to previously filed U.S. Provisional Application 63/023,804, entitled “SYSTEM AND METHOD FOR CLOSED LOOP AUTOMATION BETWEEN WIRELESS NETWORK NODES”, naming as inventor, Kenneth J. Kerpez, and filed May 12, 2020. Each reference mentioned in this patent document is herein incorporated by reference in its entirety.

### B. TECHNICAL FIELD

The present disclosure described herein generally relates to the field of communication systems and more specifically to a method and system for closed loop automation of wireless network functions and segments.

### C. BACKGROUND

Wi-Fi communication networks have moved from simple self-configurations to managed deployments for carrier-grade Wi-Fi delivering high-quality broadband. Carrier-grade Wi-Fi can be enabled by enhanced automation and cloud-based management; diagnostics, configuration, and control. Cellular systems such as 4G/5G/6G have increasing management demands and are similarly amenable to automation and cloud-based management.

Closed Loop Automation (CLA) has been described by ETSI Generic Autonomic Network Architecture (GANA). Closed loops operate between a network controller, a local controller, and a device or Managed Entity (ME). The closed loop is a control loop which has a controller optimizing or otherwise configuring the settings on a device, with no or minimal human or manual intervention. The closed loops may provide output to an open loop which provides information to a human user or operator. For some embodiments of CLAs as envisioned by ETSI GANA, the CLA may only be positioned between a controller (local or remote) and network elements.

CLAs may have limitations. For example, cloud management and control systems may not always be reachable and cloud management and control systems may have slower reaction time than a local controller. So, more flexible combinations of closed loops can be advantageous. Accordingly, what are needed are systems and methods that may improve the efficiency and performance of closed loop automation between wireless network nodes.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

FIG. 1 depicts a flow chart illustrating a method based on functions within a closed loop between nodes according to embodiments of the present document.

FIG. 2 depicts a flow chart illustrating a method based on functions of a closed loop among multiple nodes according to embodiments of the present document.

FIG. 3 depicts a simplified block diagram illustrating closed loops among multiple computing levels according to embodiments of the present document.

FIG. 4 depicts a simplified block diagram illustrating a Wi-Fi multi-AP architecture and closed loops according to embodiments of the present document.

FIG. 5 depicts a simplified block diagram illustrating a high-level 4G/5G/6G cellular system architecture according to embodiments of the present document.

FIG. 6 depicts a simplified block diagram illustrating a functional closed loop implementing CLA according to embodiments of the present document.

FIG. 7a, FIG. 7b and FIG. 7c depict simplified block diagrams illustrating closed loops between network nodes according to embodiments of the present document.

FIG. 8 depicts a simplified block diagram illustrating a roaming and mobility management closed loop according to embodiments of the present document.

FIG. 9 depicts a simplified block diagram illustrating a cloud-RAN (C-RAN) closed loop according to embodiments of the present document.

FIG. 10 depicts a simplified block diagram 1000 illustrating an edge computing closed loop according to embodiments of the present document.

FIG. 11 depicts a simplified block diagram illustrating a Fixed-Mobile Convergence (FMC) closed loop according to embodiments of the present document.

FIG. 12 depicts a simplified block diagram illustrating a network slicing closed loop according to embodiments of the present document.

FIG. 13 depicts a simplified block diagram illustrating a Coordinated Multi-Point (CoMP) or Inter-Cell Interference Coordination (ICIC) closed loop according to embodiments of the present document.

FIG. 14 depicts a simplified block diagram illustrating multiple simultaneous closed loops according to embodiments of the present document.

FIG. 15 depicts a simplified block diagram of a computing device/information handling system, in accordance with embodiments of the present document.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists the follow are examples and not meant to be limited to the listed items. Any headings used herein are for organizational purposes only and shall not be used to limit the scope of the description or the claims. Each reference mentioned in this patent document is incorporate by reference herein in its entirety.

Furthermore, one skilled in the art shall recognize that: (1) certain steps may optionally be performed; (2) steps may not be limited to the order set forth herein; (3) certain steps may be performed in different orders; and (4) certain steps may be done concurrently.

### A. Closed Loop Automation Between Wireless Network Nodes

Methods and systems for closed loop automation between wireless network nodes are described herein. A wireless network node (or simply “node”) comprises one or more of a wireless network element, wireless network function, wireless network virtual function, or wireless network segment. The wireless node may be located in any part of a wireless network, including radio access network (RAN), gateways, core network, and in control-plane functions.

In some embodiments, the Decision Elements (DE) are located in wireless network nodes and closed loop automation is performed between the nodes. This may not seem to make sense since closed loop automation was originally envisioned as a straight-forward control loop between a controller with a DE and a node with a Managed Entity (ME). However, other embodiments described herein will show useful ways to perform closed loop automation between nodes. Closed loop automation may further be envisioned between nodes, functions and network segments in particularly advantageous ways. While closed loop automation operates between nodes herein, a node may contain a DE and/or data may be collected from a node, and/or the node may be configured by a DE. The closed loop may often operate iteratively, successively operating on each node in the loop.

Decision Elements (DEs) are the intelligence of a CLA. They collect data, perform analyses, and provide output. A DE can be located in any node, controller, or management system. A DE can, and often will, use Artificial Intelligence (AI) and/or Machine Learning (ML) to perform analyses and/or to generate output. While generally associated with AI or ML, a DE may alternately perform relatively simple analyses for automation. The DE output can comprise new configurations, parameter changes, notifications, alarms, instructions, information, or more data to feed to other DEs or to human operators

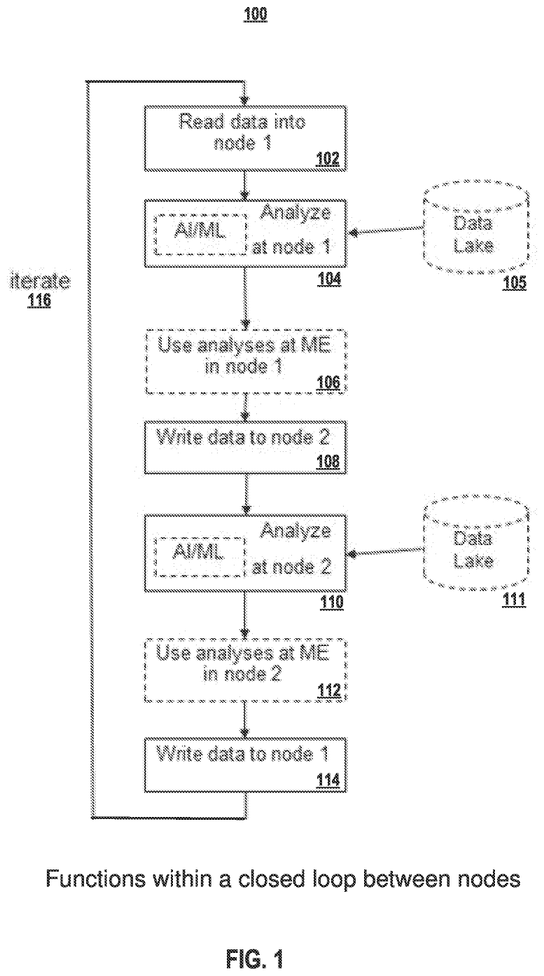

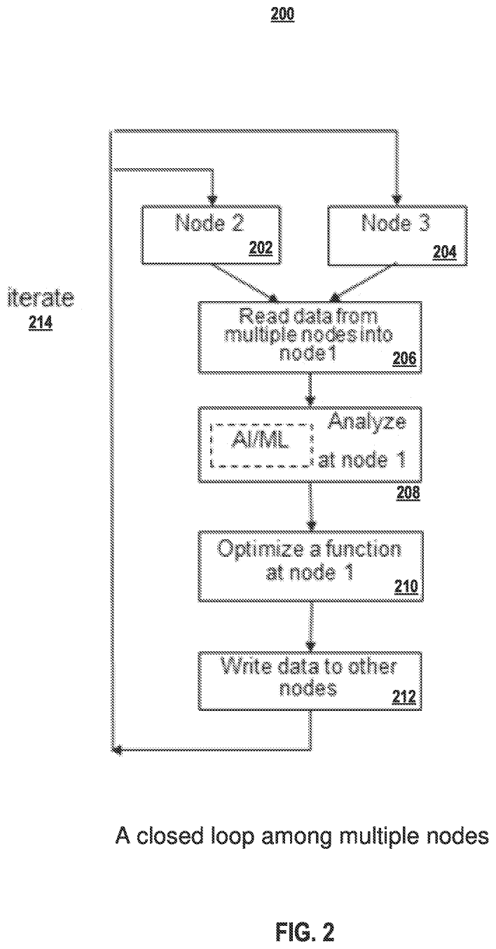

FIG. 1 and FIG. 2 show example embodiments, 100 and 200, respectively, of closed loops among network nodes. FIG. 1 depicts a flow chart illustrating a method based on functions within a closed loop between nodes according to embodiments of the present document. A control loop, closed loop, CLA, or simply loop generally operates between two or more nodes, with a first node (node 1) collecting data (step 102), performing analyses (step 104), optionally uses analyses at a managed entity (ME) in node 1 (step 106) and/or outputting information (step 106). Then a second node (node 2) further collects data (step 108), performs analyses (step 110), uses analyses at a managed entity (ME) in node 2 (step 112), and/or outputs information (step 114). Then either a third node further collect data, performs analyses, and/or outputs information (not shown), or the loop re-iterates starting at the first node again (step 116). The loop may be asynchronous, with a given node operating at a different rate than another node. Loops can be fast, slow, inner, outer, hierarchical, distributed, orchestrated, configured and adapted.

Relative to FIG. 1, data is read into the ME in node 1 (step 102), such that data may include diagnostics or performance data. Then, an analyses is performed by a DE in node 1 (step 104) using that data and perhaps also data from a data lake 105, database, or data warehouse. The analyses (step 104) may include artificial intelligence (AI) or machine learning (ML) functions, for example to determine better parameter settings, or to find the cause of errors. The data may then be used at node 1 (step 106), for example to optimize parameter settings, improve performance or fix faults. Then another set of data is written to the ME in node 2 (step 108), and then analyses are performed by a DE in node 2 (step 110) using that data, and perhaps also data from a data lake 111. The data may then be used at node 2, for example to optimize parameter settings, improve performance or fix faults (step 110 and step 112). Further, another data set is written back to node 1 (step 114), thereby closing the loop. Dashed lines on figures herein indicate the function or coupling is optional.

FIG. 2 depicts a flow chart illustrating a method based on functions of a closed loop among multiple nodes according to embodiments of the present document. First, data is read from multiple other nodes, for example node 2 and node 3, (step 202, step 204) into the ME at node 1 (step 206). Then, the DE at node 1 performs analyses (step 208), where the analyses may use AI or ML functions. Using the analyses results, a function in node 1 may be optimized or improved (step 210). Then a set of data is written to other nodes (step 212, step 214), which may themselves use the data and perform analysis (step 202, step 204), and then data is further written back into node 1 (step 206), closing the loop. The loop re-iterates starting at the second node (node 2) and third node (node 3) again.

A network node can contain DEs and MEs. Typically nodes with high computing power, such as computing platforms, have DEs, while nodes that are less “intelligent” have MEs. For example, a cloud computing node may have a DE, while a small Internet of Things (IoT) device has an ME. However, the wireless network nodes considered here will often have both DEs and MEs, since the nodes operate on each other in closed loops amongst themselves.

DEs and loops can be network-level, node-level, function-level, or protocol-level. The DE may interact with a ME on the same node or on another node. MEs can perform network functions themselves while receiving input. DEs can operate in the control plane or intelligence plane. MEs can operate in the data plane or user plane.

A function within a node may serve as both a DE and an ME. For example, an ML function may serve as a DE that feeds the output of a pattern recognition model to an ME in another node in a lower loop, while that same function also serves as an ME by receiving model coefficients or model structure calculated by a DE in a node in an upper loop.

Closed loops may perform optimization of networks, devices, services or applications. The closed loops may perform diagnostics and may identify faults or areas of low performance. The closed loops may perform network re-configuration toward improving or optimizing performance. The closed loops may provide output to an open loop which provides information to a human user or operator. Closed loops may implement functions or services related to fault, configuration, accounting, performance monitoring, provisioning, network planning, or security. Closed loops may implement functions or services including resource allocation, traffic prediction, quality of experience (QoE) assessments, assignments for quality of service (QoS), route planning, spectrum management, fault diagnostics, root cause, fault correlation, and network optimization.

Multiple closed loops can run in coordination with each other, for example for joint optimization between loops. A first loop diagnoses and configures a particular network domain (e.g., a network segment, function or service). Then, this is further iterated on by a second loop, which diagnoses and configures a different domain. Many such loops can run together, altogether this creates a unique type of distributed system. The multiple loops may be explicitly coordinated, e.g., by an orchestrator or controller. Or the multiple loops may only implicitly operate together by the interactions between their domains.

### B. Pipeline

Data gathering, analyses, and output are coordinated and automated between the DEs and wireless network nodes. The DE may analyze input, perform analyses and determine output in a Machine Learning (ML) pipeline, consisting of pipeline components such as collector, pre-processor, model, policy, and distributor; which may be defined as:
C (collector): This is responsible for collecting data from one or more sources. A collector may have the capability to configure sources; such configurations may be used to control the nature of data, its granularity and periodicity.
PP (preprocessor): This is responsible for cleaning data, aggregating data or performing any other preprocessing needed for the data to be in a suitable form so that the ML model can consume it.
M (model): This is a machine learning model, in a form which is usable in a machine learning pipeline.
P (policy): This enables the application of policies to the output of the model. Specific rules can be put in place by a network operator to safeguard the sanity of the network, e.g., major upgrades may be done only at night time or when data traffic in the network is low.
D (distributor): This is responsible for distributing the output of the model to the corresponding data sinks. It may have the capability to configure data sinks.

A DE may be located in any node involved in CLA, and the DE may implement any one or more of the ML pipeline components described above: collector, pre-processor, model, policy, and distributor. The DE can operate on a managed entity (ME), or on another node or function.

### C. Virtual Function Nodes

Virtualization is becoming popular, with network functions running in the cloud, data center, edge computing, or on hosting platforms in devices. A combination of platforms can be used, such as with fog computing. Cloud can comprise all such virtualized platforms. There can be multiple types of computing associated with a wireless network, including virtualized functions, bare metal servers, and on devices themselves.

A virtual network function (VNF) runs on virtual computing infrastructure such as a cloud, data center, or edge computing platform. VNFs generally serve as DEs, but can also be MEs. VNFs can be controlled and managed by one or more of an orchestrator, VNF manager (VNFM), virtual infrastructure manager (VIM), software defined network (SDN) controller, or SDN management and control (M&C). Often there is a collection of physical nodes or physical network functions (PNFs) such as network elements, and an associated collection of virtual functions or nodes, with the virtual functions located remotely. Physical functions may operate on network elements (NEs) or devices in the network, with virtual functions operating on virtual computing infrastructure such as a cloud, data center, or edge computing platform. Virtual functions can also be hosted on network elements or devices such as user equipment (UE). Physical functions may operate on the data plane, with virtual functions operating on the control plane. Nodes can be physical or virtual, or encompass both physical and virtual functions

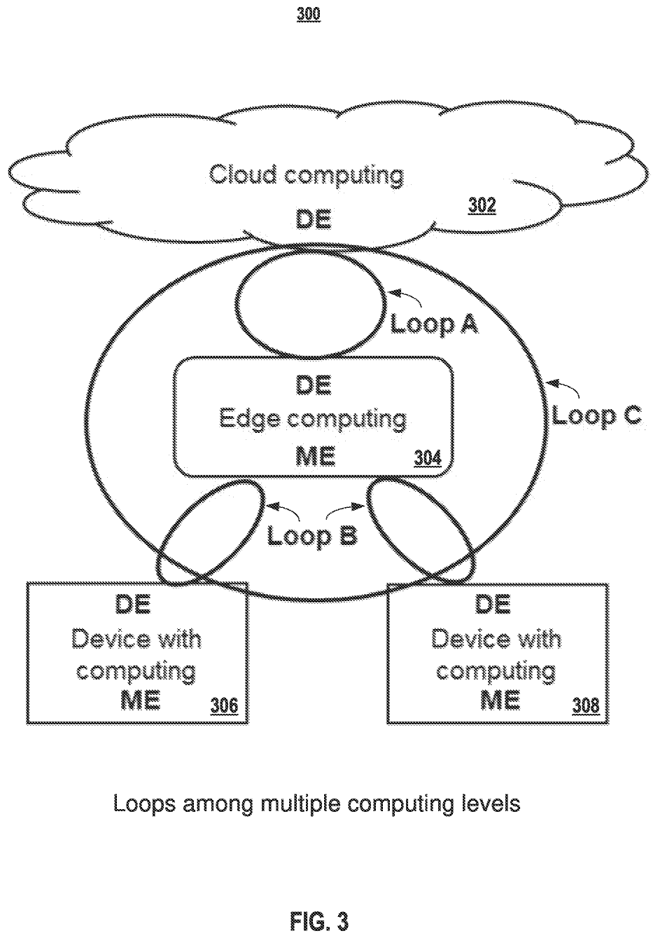

FIG. 3 depicts a simplified block diagram 300 illustrating closed loops among multiple computing levels according to embodiments of the present document. Loop A is runs between a cloud computing node 302 and an edge computing node 304. Loop B runs between an edge computing node 304 and a device, either device 306 or device 308, which have local computing. Loop C runs between a cloud computing node 302 and devices 306/308, which have local computing. Any of these loops may contain DEs or MEs.

A node can comprise physical functions and virtual functions. Closed loops can operate between groups of physical functions and virtual functions or amongst a set of physical functions and virtual functions. In other words, A DE can be a PNF or a VNF.

A node can interact with an orchestration system, management system, database, data lake, data warehouse, and big data. Or a node may encompass a database, data lake, data warehouse, or big data. A CLA can operate over long timescales between a node and a database, data lake, data warehouse, or big data.

### D. Wireless

Closed loop automation, as described herein, can be performed among nodes of a wireless communication network. Wireless communication encompasses Wi-Fi, including all types of IEEE 802.11 and Wi-Fi Alliance CERTIFIED systems and methods, low-power communication including Bluetooth, Zigbee, Z-wave, and LoRaWAN; and cellular systems including third-generation 3G, fourth-generation 4G, fifth-generation 5G, sixth-generation 6G, Long-Term Evolution (LTE), and New Radio (NR).

A wireless network node can be a physical node such as a base station (eNodeB) or gateway, a function such as a control plane function or database, or a network segment such as the Radio Access Network (RAN) or core network.

### E. Example Embodiment: Wi-Fi

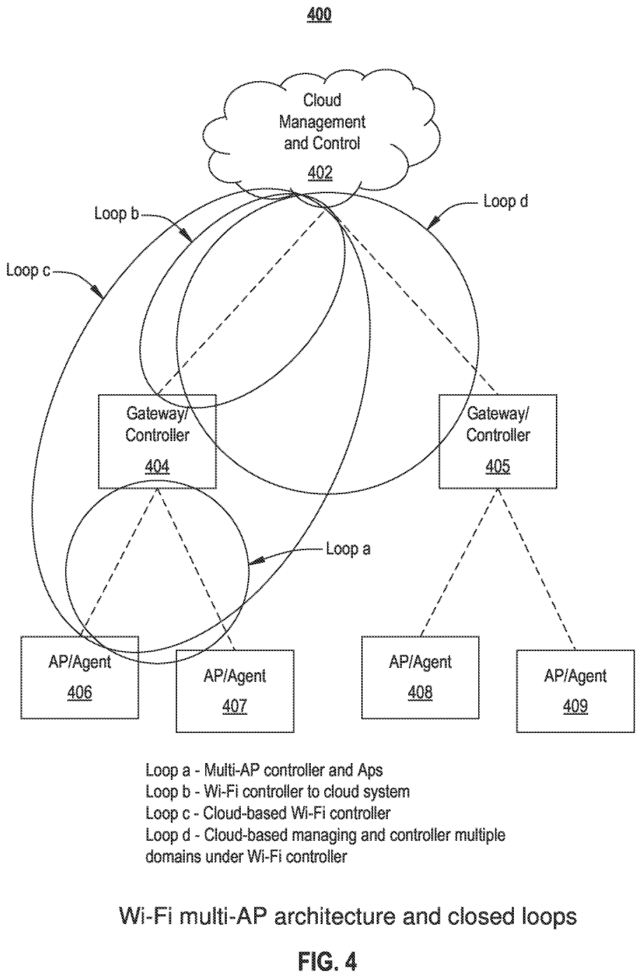

FIG. 4 depicts a simplified block diagram 400 illustrating a Wi-Fi multi-AP architecture and closed loops according to embodiments of the present document. Effectively, FIG. 4 shows an example embodiment of closed loops with Wi-Fi network nodes. The embodiment comprises multiple closed loops for automation (CLA) of Wi-Fi management and control, with particular management of multiple Wi-Fi Access Points (APs). The hierarchy of local and cloud management presented in this use case can provide a platform for distributed intelligence to optimize the user's Wi-Fi experience.

AI in cloud management of Wi-Fi can analyze large datasets to determine optimal channel assignments and station associations for combinations of time-of-day and traffic demands across multiple multi-AP domains.

Cloud management and control systems may not always be reachable and cloud management and control systems may have slower reaction time than a local controller. In these cases, some local control can be helpful. For example, a local controller can react fast enough to change station association without interrupting a voice call. AI in Wi-Fi controllers can complement local controllers by using more compute power and large datasets. So, different control loops, operating across a LAN or across the WAN, can have complementary uses. There are four closed loops in FIG. 4:

Loop a implements a local Multi-AP controller interacting with APs. This uses a controller 404 to manage a multi-AP domain, with an agent in each AP (e.g., AP/Agent 406, AP/Agent 407), and perform channel assignment and station steering, etc. The controller 404 resides on a device in the premises and communicates with agents. Controller 404 may be located at a gateway.

Loop b is between a controller 404 and a cloud management and control system 402. In loop b, the controller 404 can provide data to the cloud management and control system 402. The cloud management and control system 402 further manages and refines the diagnostics and control which are performed by the controller 404. In particular, the cloud management and control system 402 can use long-term historical data.

Loop c has the cloud management and control system 402 acting as a controller, or equivalently using a cloud-based controller. Loop c may be coupled between cloud management and control system 402, and AP/Agent 406 and/or AP/Agent 407.

Loop d has the cloud management and control system 402 managing and controlling multiple domains under controllers. The cloud management and control system 402 can, for example, assign channels that may or may not be used in each multi-AP domain to avoid interference. Loop d may be coupled between cloud management and control system 402 and controller 404 and controller 405. Controller 404 and controller 405 may be located at a gateway. Controller 405 maybe coupled to AP/Agent 408 and AP/Agent 409.

Some of these loops may or may not be used, and they may operate independently or in coordination. The specifications for the control, agents, and their interfaces may be based on Wi-Fi Alliance (WFA) Wi-Fi CERTIFIED EasyMesh™. For example, controller 404 and controller 405 may be EasyMesh Controllers, and AP/Agent 406/407/408/409 may be AP EasyMesh Agents.

Additional closed loops may extend into a Wide Area Network (WAN). For example broadband access lines or network elements, such as access nodes, can be in an additional loop with Wi-Fi cloud, controller, or AP. Access nodes can be Digital Subscriber Line Access Multiplexers (DSLAMs), Optical Line terminals (OLTs), Ethernet switches, Cable Modem Termination Systems (CMTS), or similar. There can also be a closed loop with the broadband aggregation network.

### F. High-Level Cellular Architecture

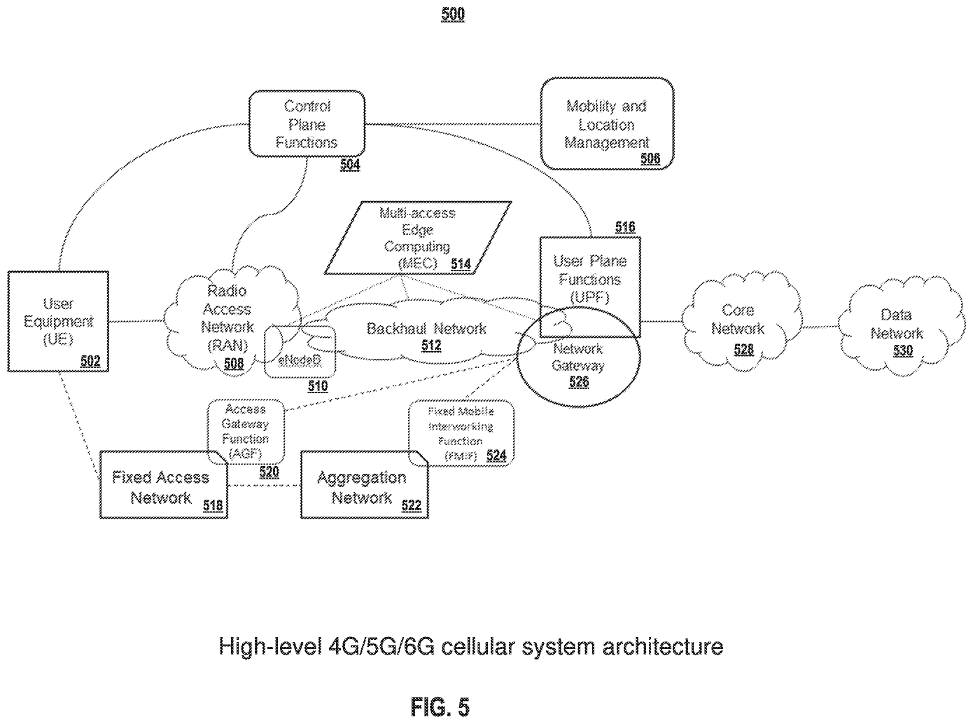

FIG. 5 depicts a simplified block diagram 500 illustrating a high-level 4G/5G/6G cellular system architecture according to embodiments of the present document. The functions and network segments depicted in the example embodiments here are simplified. The functions in FIGS. 5-14 may comprise any of the following network functions (NF), and network entities, including:

Network Functions:
Authentication Server Function (AUSF)
Access and Mobility Management Function (AMF)
Data Network (DN)
Unstructured Data Storage Function (UDSF)
Network Exposure Function (NEF)
Intermediate NEF (I-NEF)
Network Repository Function (NRF)
Network Slice Selection Function (NSSF)
Policy Control Function (PCF)
Session Management Function (SMF)
Unified Data Management (UDM)
Unified Data Repository (UDR)
User Plane Function (UPF)
UE radio Capability Management Function (UCMF)
Application Function (AF)
5G-Equipment Identity Register (5G-EIR)
Network Data Analytics Function (NWDAF)
Charging Function (CHF)
Security Edge Protection Proxy (SEPP)
Evolved Packet Core (EPC)
Policy Control and Charging Rules Function (PCRF)
Home Subscriber Server (HSS)
Packet Data Network (PDN) Gateway (P-GW or PGW)
Serving Gateway (S-GW or SGW)
Evolved Packet Data Gateway (ePDG)
Policy Control Enforcement Function (PCEF)
Radio Resource Management Function (RRM)
Mobility Management Entity (MME)
Access Network Discovery and Selection Function (ANDSF)
Network controller
Software Defined Network (SDN) controller
IP Multimedia Subsystem (IMS)
Home Location Register (HLR)
Service Capabilities Exposure Function (SCEF)

Network entities:
evolved base station (eNodeB)
Base station
User Equipment (UE)
Radio Access Network (RAN)
Service Communication Proxy (SCP)
Security Edge Protection Proxy (SEPP)
Non-3GPP InterWorking Function (N3IWF)
Trusted Non-3GPP Gateway Function (TNGF)
Wireline Access Gateway Function (W-AGF or AGF) 520
Public Land Mobile Network (PLMN)
Data Network (DN)
Core Network
Aggregation Network
Edge Network
Backhaul Network
Fronthaul
Remote Radio Head (RRH)
Baseband Unit (BBU)
Multi-access Edge Computing (MEC)
Access Node (AN)
Broadband Network Gateway (BNG)
Fixed Mobile Interworking Function (FMIF)

In FIG. 5, the Radio Access Network (RAN) 508 may comprise eNodeB(s) 510, base stations, radios, antennas, RRH, BBU, repeaters, radio relays, cells, small cells, femtocells, and picocells.

User Equipment (UE) 502 may comprise handsets, smartphones, computers, terminals, residential gateways (RG), Fixed Network RGs, 5G RG, small cells, femtocells, and picocells.

The fixed access network 518 may comprise wireline or optical-fiber based broadband, fixed wireless, powerline communications, copper, DSL, G.fast, coax, access nodes, fronthaul, switches, routers, and access gateway function (AGF) 520.

The aggregation network 522 may comprise Ethernet-based backhaul, IP-based backhaul, fiber-based backhaul, copper-based backhaul, coax-based backhaul, powerline communications, Broadband Network Gateway (BNG), Broadband Remote Access Server (BRAS), aggregation nodes, backhaul, switches, routers, and Fixed Mobile Interworking Function (FMIF) 524.

Control Plane Functions 504 may comprise AUSF, AMF, UDSF, NEF, I-NEF, NRF, NSSF, PCF, SMF, UDF, UDR, UCMF, AF, 5G-EIR, CHF, SEPP, EPC, PCRF, P-GW or PGW, S-GW or SGW, ePDG, PCEF, RRM, MME, ANDSF, Network controller, and SDN controller.

Backhaul network 512, core network 528, and UPF 516 may comprise PDN, P-GW or PGW, S-GW or SGW), network gateways 526, ePDG, Wide-Area Network (WAN), backhaul network, Ethernet-based backhaul, IP-based backhaul, switches, routers, fiber-based backhaul, copper-based backhaul, coax-based backhaul, RRH, BBU, SCP, SEPP, N3IWF, W-AGF or just AGF 520, PLMN, and DN. The backhaul network may comprise an aggregation network 522. Core Network 528 may be coupled to Data Network 530.

The network gateway 526 may comprise PDN, P-GW or PGW, S-GW or SGW, ePDG, TNGF, W-AGF or AGF 520, and BNG.

Mobility management and location functions may comprise HSS, MME, UDM, UDR, HLR, SEPP, UDSF, virtual SEPP (vSEPP), home SEPP (hSEPP), Virtual PLMN (VPLMN), Home PLMN (HPLMN), NRF, AUSF, PCF, NEF, SCEF, and IMS.

Edge computing can have rapid reactions with low delay since the edge is close to a node or group of nodes. Multi-access Edge Computing (MEC) 514, or more simply just “edge computing,” may comprise compute infrastructure, virtual infrastructure, interfaces, CPU, storage, cache, Cloud CO, edge computing, cloud computing, and fog computing. Machine learning may operate by having edge computing train a model, then the trained model is transferred to a device. Similarly, the model may be trained in the cloud, then transferred to edge computing or to a device. Closed loops can operate amongst cloud, edge, and device.

These functions and network entities, except for the control plane functions 504 and mobility and location management 506, may be considered to be part of the user plane or data plane

### G. Cellular Embodiments

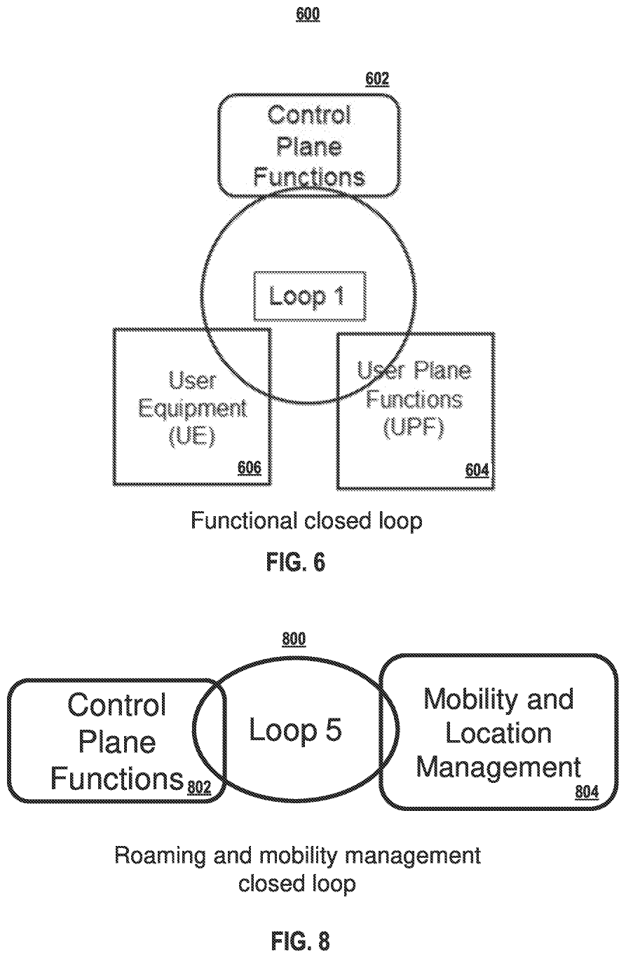

FIG. 6 depicts a simplified block diagram 600 illustrating a functional closed loop implementing CLA according to embodiments of the present document. Control plane functions 602 interacts in a loop with User Plane Functions (UPF) 604 and User Equipment (UE) 606 nodes. The control plane functions 602 and User Plane Functions (UPF) 604 can be jointly diagnosed and optimized, for example, to provide consistent QoS and QoE. FIG. 6 comprises Loop 1, which is a closed loop that couples control plane functions 602, UPF 604 and UE 606.

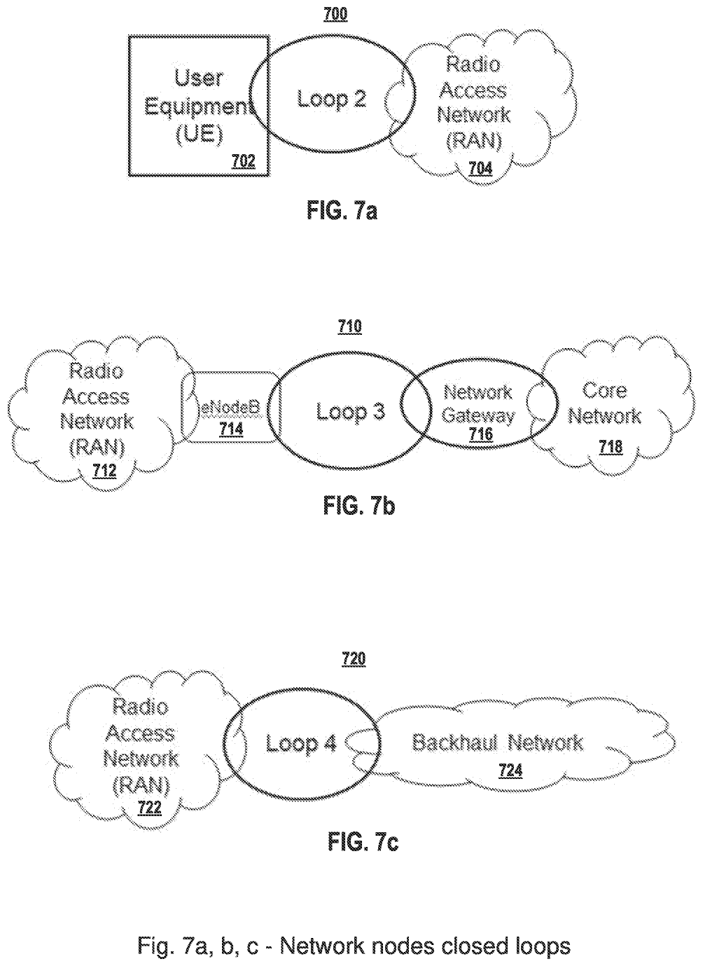

FIG. 7a, FIG. 7b and FIG. 7c depict simplified block diagrams 700, 710 and 720, respectively, illustrating closed loops between network nodes according to embodiments of the present document. FIG. 7a, via Loop 2, shows CLA operating across UE 702 and RAN 704 nodes. The UE 702 and RAN 704 can be jointly diagnosed and configured, for example, to determine root cause of network failures. FIG. 7b, via Loop 3, shows CLA operating across RAN 712, eNodeB 714, and core network 718 including network gateway 716. The RAN 712, eNodeB 714, network gateway 716, and core network 718 can be jointly diagnosed and configured, for example, to determine root cause of network failures. A similar embodiment to FIG. 7b, via Loop 3, may additionally comprise a backhaul network. FIG. 7c, via Loop 4, shows CLA operating across RAN 722 node and backhaul network 724. The RAN 722 and backhaul network 724 can be jointly diagnosed and configured, for example, to determine root cause of network failures.

FIG. 8 depicts a simplified block diagram 800 illustrating a roaming and mobility management closed loop according to embodiments of the present document. More specifically, FIG. 8 shows a roaming and mobility management closed loop, Loop 5, across a control plane functions 802 node and a mobility and location management 804 node. Note that the UE and RAN may also be included in a roaming and mobility management closed loop. In this case, roaming and mobility can be jointly monitored and configured, for example, to enable rapid handoffs for a UE as it roams between multiple RANs.

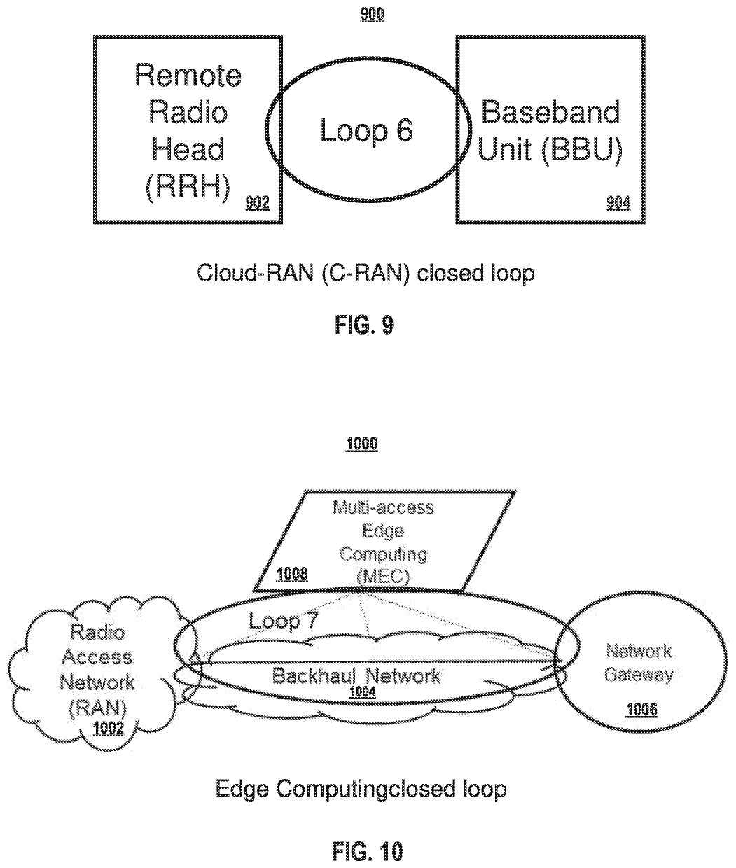

FIG. 9 depicts a simplified block diagram 900 illustrating a cloud-RAN (C-RAN) closed loop with a loop between remote radio head (RRH) 902 and baseband unit (BBU) 904, according to embodiments of the present document. C-RAN may use the Common Public Radio Interface (CPRI) for communication between RRH 902 and BBU 904. The fronthaul interfaces and operation can be jointly diagnosed and configured, for example, to minimize bandwidth usage while maximizing performance.

FIG. 10 depicts a simplified block diagram 1000 illustrating an edge computing closed loop, Loop 7, according to embodiments of the present document. As shown via Loop 7, edge computing is logically positioned in or between RAN 1002, and the network gateway 1006. Edge computing is embodied here by MEC 1008. The edge computing closed loop is among RAN 1002, MEC 1008, backhaul network 1004 and network gateway 1006. Here the edge computing platform and the network segments can be jointly diagnosed and configured, for example to minimize delay for an end user accessing edge computing.

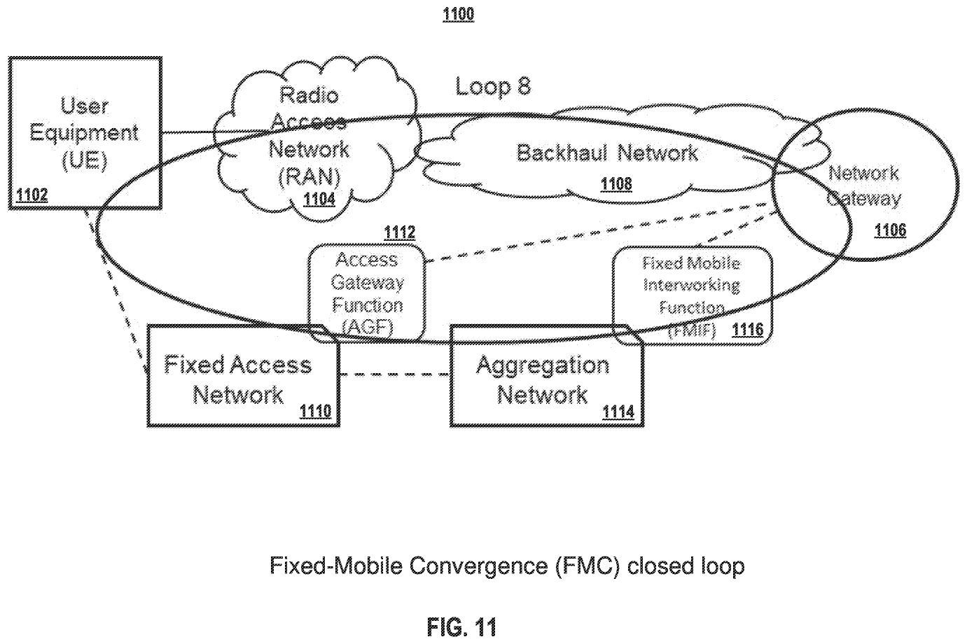

FIG. 11 depicts a simplified block diagram 1100 illustrating a Fixed-Mobile Convergence (FMC) closed loop according to embodiments of the present document. This closed loop, Loop 8, runs among UE 1102, RAN 1104, backhaul network 1108, fixed access network 1110, and aggregation network 1114. Loop 8 can also include network gateway 1106, AGF 1112, and FMIF 1116 nodes. Here the fixed network and mobile network can be jointly monitored, for example, to ensure sufficient and consistent QoS across the two networks.

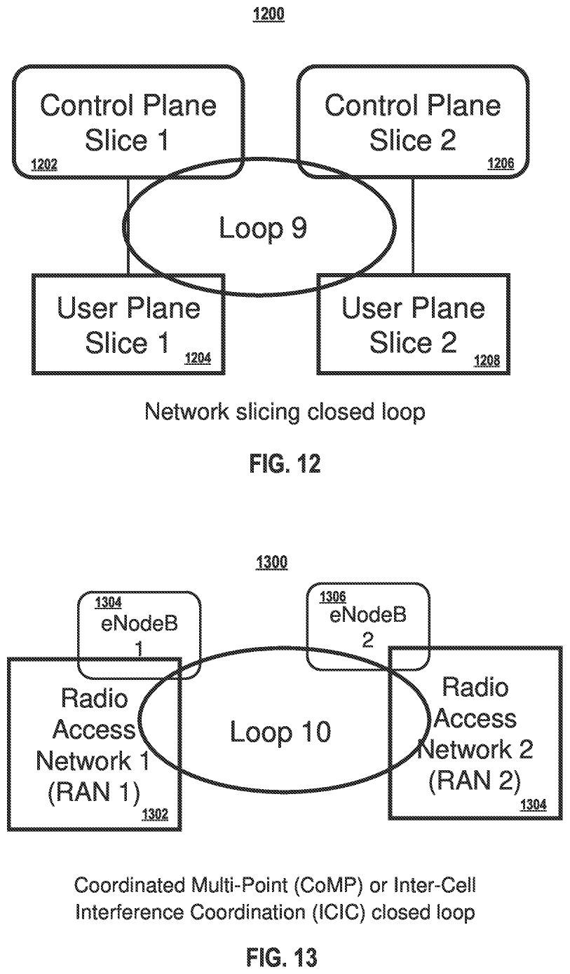

FIG. 12 depicts a simplified block diagram 1200 illustrating a network slicing closed loop (Loop 9) according to embodiments of the present document. Different slices may support different classes of service with different quality of service goals, or different slices may support different applications or different operators. CLA may be positioned among different slices including control plane nodes and user plane nodes. Loop 9 comprises control plane for slice 1 1202, user plane for slice 1 1204, control plane for slice 2 1206, and user plane for slice 2 1208. Here slicing can be diagnosed and configured, for example, to identify violations in slice assignments and correct them.

FIG. 13 depicts a simplified block diagram 1300 illustrating a Coordinated Multi-Point (CoMP) or Inter-Cell Interference Coordination (ICIC) closed loop (Loop 10) according to embodiments of the present document. Effectively, FIG. 13 shows CLA among multiple RAN and multiple eNodeB. This closed loop (Loop 10) can implement Coordinated Multi-Point (CoMP) or Inter-Cell Interference Coordination (ICIC) to improve performance jointly among the multiple RAN (RAN1-1302, RAN2-1304) and multiple eNodeB (eNodeB1 1304, eNodeB2 1306).

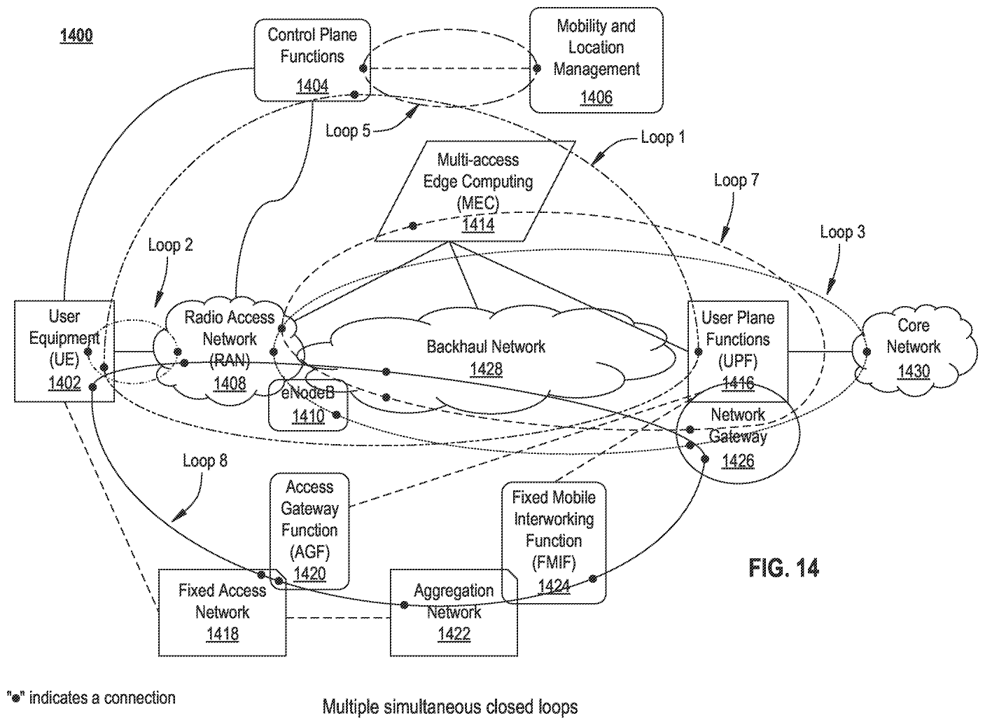

FIG. 14 depicts a simplified block diagram 1400 illustrating multiple simultaneous closed loops according to embodiments of the present document. FIG. 14 shows an example of multiple closed loops operating together, as illustrated via loops 1, 2, 3, 5, 7 and 8.
Loop 1 coupled among control plane functions 1404, user plane functions (UPF) 1416, and User Equipment (UE) 1402;
Loop 2 coupled among UE 1402 and RAN 1408. RAN 1408 is associated with eNodeB 1410;
Loop 3 coupled among RAN 1408, eNodeB 1410, network gateway 1426, and core network 1430. Loop 3 is not coupled to backhaul network 1428 or user plane functions (UPF) 1416;
Loop 5 coupled among a control plane functions 1404 node and a mobility and location management 1406 node;
Loop 7 coupled among RAN 1408, MEC 1414, backhaul network 1428, and network gateway 1426. Loop 7 is not coupled to user plane functions (UPF) 1416, or eNodeB 1410;
Loop 8 coupled among UE 1402, RAN 1408, backhaul network 1428, fixed access network 1418, and aggregation network 1422, and can also include, network gateway 1426, AGF 1420 and FMIF 1424 nodes. Backhaul network 1428 can be coupled to core network 1430.

The multiple loops may be combined for a particular application or instance of diagnostics or configuration. Any of the loops shown here may be operating or not, and they may be coordinated or not.

A backhaul network is the first backhaul from a RAN or eNodeB. Backhaul networks in a wireless network are analogous to aggregation networks in fixed broadband networks.

Loops can also be positioned between Wi-Fi and cellular systems, networks, and nodes, in order to support offloading from cellular to Wi-Fi, or to support roaming, or to support multi-access.

In addition to the loops for cellular systems explicitly shown in the aforementioned figures, additional loops may include more than one instance of each network node shown in each figure. Loops shown in any two or more figures may be combined or may operate independently or in coordination.

In some embodiments, a method of closed loop automation may be applied to a wireless communications network. One or more closed loops may operate among a plurality of wireless network nodes, wherein each wireless network nodes may comprise one or more of a wireless network function, wireless control function, wireless network element, or wireless network segment. Data collection, analysis, and output may be performed by multiple decision elements. One or more decision element may not be a controller. Moreover, the decision elements may reside in multiple wireless network nodes and the decision elements may provide data to one or more managed entities, and the provided data may affect the operation of the managed entities. The analysis may involve artificial intelligence or machine learning. A closed loop operates on a managed entity (ME).

In other embodiments, a method of closed loop automation may be applied to a Wi-Fi network, wherein multiple closed loops operate among a plurality of wireless network nodes, and wherein data collection, analysis, and output are performed by multiple decision elements. The decision elements may reside in multiple wireless network nodes, the decision elements may provide data to one or more managed entities, and the provided data may affect the operation of the managed entities. The closed loops may comprise: i) a loop between a local multi-access point (multi-AP) controller and one or more access points (APs), ii) a loop between a local multi-access point (multi-AP) controller and a cloud management and control system, iii) a loop between a cloud management and control system and one or more access points (APs), and iv) a loop between a cloud management and control system and more than one local multi-access point (multi-AP) controller.

A wireless communications network is a cellular network and the closed loops comprise one or more of: a functional closed loop, a wireless network node closed loop, a roaming and mobility management closed loop, a cloud-RAN (C-RAN) closed loop, an edge computing closed loop, a Fixed-Mobile Convergence (FMC) closed loop, a network slicing closed loop, a coordinated Multi-Point (CoMP), an Inter-Cell Interference Coordination (ICIC) closed loop a closed loop between a Wi-Fi network node and a cellular network node.

The multiple closed loops may operate and interact in a coordinated manner, wherein the interaction in a coordinated manner forms a distributed system. A closed loop may further provide output to an open loop that may provide information to a human user or operator. There can be multiple layers of computing, including one or more of cloud computing, edge computing, and local computing on a device. A wireless network node may comprise virtual functions or physical functions. A closed loop operates between a physical function and a virtual function. A closed loop operates amongst a set of physical functions and virtual functions.

The method may further involve interaction with one or more of: an orchestrator, virtual network functions manager, Software-defined network (SDN) controller SDN management and control, a database, a data lake, a data warehouse, or big data.

A closed loop may operate for one or more of the following purposes: optimization of networks, devices, services or applications, diagnostics, identification of faults, identification of areas of low performance, fault management, fault correlation, configuration, accounting, performance monitoring, provisioning, network planning, security, resource allocation, traffic prediction, quality of experience (QoE) assessments, assignments for quality of service (QoS), route planning, spectrum management, root cause determination, or network optimization.

### H. System Embodiments

In embodiments, aspects of the present patent document may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), a network storage device, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, touchscreen and/or a video display. The computing system may also include one or more buses operable to transmit communications between the various hardware components.

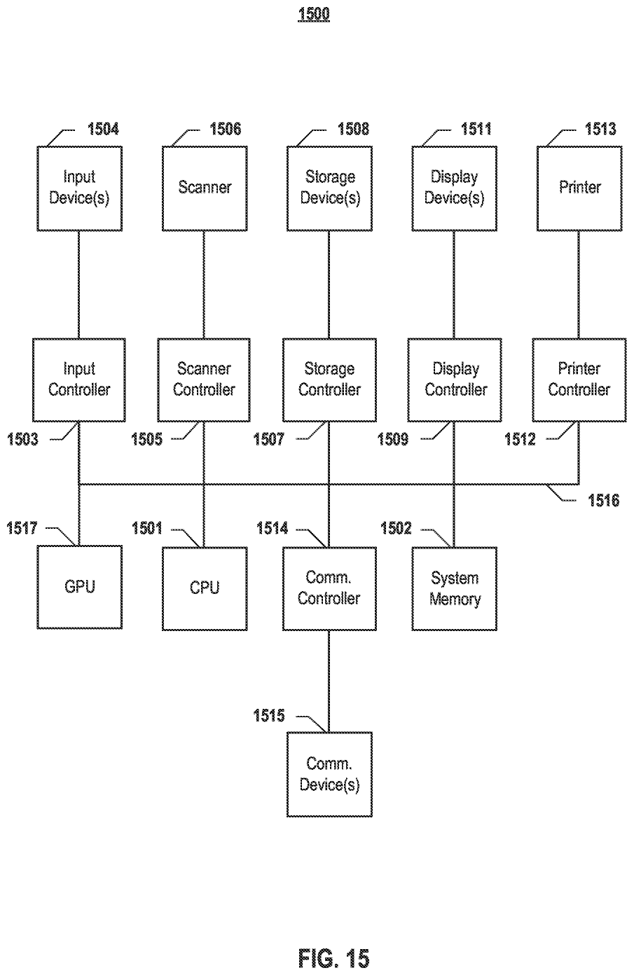

FIG. 15 depicts a simplified block diagram of a computing device/information handling system 1500 (or computing system) according to embodiments of the present disclosure. It will be understood that the functionalities shown for system 1500 may operate to support various embodiments of an information handling system—although it shall be understood that an information handling system may be differently configured and include different components.

As illustrated in FIG. 15, system 1500 includes one or more central processing units (CPU) 1501 that provides computing resources and controls the computer. CPU 1501 may be implemented with a microprocessor or the like, and may also include one or more graphics processing units (GPU) 1517 and/or a floating point coprocessor for mathematical computations. System 1500 may also include a system memory 1502, which may be in the form of random-access memory (RAM), read-only memory (ROM), or both.

A number of controllers and peripheral devices may also be provided, as shown in FIG. 15. An input controller 1503 represents an interface to various input device(s) 1504, such as a keyboard, mouse, or stylus. There may also be a scanner controller 1505, which communicates with a scanner 1506. System 1500 may also include a storage controller 1507 for interfacing with one or more storage devices 1508 each of which includes a storage medium such as magnetic tape or disk, or an optical medium that might be used to record programs of instructions for operating systems, utilities, and applications, which may include embodiments of programs that implement various aspects of the present invention. Storage device(s) 1508 may also be used to store processed data or data to be processed in accordance with the invention. System 1500 may also include a display controller 1509 for providing an interface to a display device 1511, which may be a cathode ray tube (CRT), a thin film transistor (TFT) display, or other type of display. The computing system 1500 may also include a printer controller 1512 for communicating with a printer 1513. A communications controller 1514 may interface with one or more communication devices 1515, which enables system 1500 to connect to remote devices through any of a variety of networks including the Internet, a cloud resource (e.g., an Ethernet cloud, an Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 1516, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

Computing system 1500 may be virtualized and hosted in a data center, on virtual machines, or hosted in containers. Then, blocks 1501-1517 may be embodied as virtual functions or network services instead of being part of a single physical system or bare-metal system.

One skilled in the art will recognize no computing system or programming language is critical to the practice of the present invention. One skilled in the art will also recognize that a number of the elements described above may be physically and/or functionally separated into sub-modules or combined together. It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A wireless network node comprising:
a plurality of closed loop interfaces coupled to cloud management and control and a plurality of other wireless network nodes, the plurality of closed loop interfaces receives performance data related to at least one of a control plane and a user plane associated with the plurality of other wireless network nodes;
a decision element communicatively coupled to receive the performance data, the decision element analyzes the performance data and generates at least one operational command that improves a performance of at least one control plane function or user plane function; and
wherein the at least one operational command is transmitted on a first closed loop interface within the plurality of closed loop interfaces to a managed entity, the managed entity modifies an action in accordance with the at least one operational command.

2. The wireless network node of claim 1 wherein the modified action improves performance of the control plane.

3. The wireless network node of claim 1 wherein the modified action improves performance of the user plane.

4. The wireless network node of claim 1 wherein the wireless network node is a user equipment coupled within a cellular network having at least one closed loop coupling the wireless network node to control plane functions and user plane functions that implement a functional closed loop.

5. The wireless network node of claim 1 wherein the wireless network node is a user equipment coupled within a cellular network having at least one closed loop coupling the wireless network node to a radio access network.

6. The wireless network node of claim 1 wherein the plurality of closed loops is coordinated.

7. The wireless network node of claim 1 wherein the wireless network node is a mobility and location management node that is coupled via a first closed loop interface to control plane functions to implement a roaming and mobility closed loop.

8. The wireless network node of claim 1 wherein the wireless network node is an eNodeB that is coupled via a first closed loop interface to a network gateway within a core network.

9. The wireless network node of claim 1 wherein the wireless network node is an edge computing node coupled to a first closed loop interface to a radio access network.

10. The wireless network node of claim 1 wherein the wireless network node is a remote radio head node that is coupled via a first closed loop interface to a baseband unit to implement a cloud-RAN closed loop.

11. The wireless network node of claim 1 wherein the wireless network node is a node selected from a group consisting of a multi-access edge computing node, a radio access network node and a network gateway node, the wireless network node being coupled within an edge computing closed loop to manage backhaul connectivity between a radio access network and a network gateway.

12. The wireless network node of claim 1 wherein the wireless network node is a node selected from a group consisting of a user equipment, fixed access network node, aggregation network node, and a network gateway node, the wireless network node being coupled within a fixed-mobile convergence closed loop to manage at least one of a radio access network and a backhaul network.

13. The wireless network node of claim 1 wherein the wireless network node is an edge computing node coupled to a plurality of access points across located within at least two networks.

14. A multi-access edge computing node comprising:
a first closed loop interface coupled to a radio access network, the first closed loop interface receives first performance data from the radio access network across a first user plane and a first control plane, the radio access network having at least one first node with a first managed entity;
a second closed loop interface coupled to a network gateway, the second closed loop interface receives second performance data from the network gateway across a second user plane and a second control plane, the gateway network having at least second node with a second managed entity;
a third interface coupled to a backhaul network located between the radio access network and the network gateway, the third interface receives third performance data from the backhaul network; and
a decision element communicatively coupled to receive the first, second and third performance data, the decision element jointly analyzes the first, second and third performance data and generates an operational command that is transmitted to at least one of the first and second nodes.

15. The multi-access edge computing node of claim 14 wherein the first and second closed loop interfaces are integrated into a single interface.

16. The multi-access edge computing node of claim 14 wherein the operational command reduces delay for an end user accessing edge computing.

17. A method for managing network performance, the method comprising:
receiving a first set of performance data from a plurality of wireless nodes via a first closed loop, the first set of performance data related to both a control plane and a user plane;
receiving a second set of performance data from cloud management and control via a second closed loop;
jointly analyzing the first and second sets of performance data to generate at least one operational command; and
transmitting the at least one operational command to a managed entity located in a first wireless node.

18. The method of claim 17 wherein the first wireless node is within the plurality of wireless nodes.

19. The method of claim 17 wherein the first wireless node is a mobility and location management node and the at least one operational command is transmitted on a roaming and mobility closed loop.

20. The method of claim 17 wherein the first wireless node is a node selected from a group consisting of a multi-access edge computing node, a radio access network node and a network gateway node, the first wireless network node being coupled within an edge computing closed loop to manage backhaul connectivity between a radio access network and a network gateway.
